(19) United States
(12) Patent Application Publication
(10) Pub. No.: US 2012/0269494 A1
(43) Pub. Date: Oct. 25, 2012

(54) AUGMENTED REALITY FOR LIVE EVENTS

(75) Inventors: Madhukara B. Satyanarayana, San Diego, CA (US); Strachan P. Barclay, San Diego, CA (US)

(73) Assignee: QUALCOMM Incorporated, San Diego, CA (US)

(21) Appl. No.: 13/310,439

(22) Filed: Dec. 2, 2011

Related U.S. Application Data
(60) Provisional application No. 61/478,416, filed on Apr. 22, 2011.

(51) Int. Cl. H04N 9/80

(52) U.S. Cl. 386/248; 386/E05.001

(57) ABSTRACT

Arrangements for using augmented reality in conjunction with a live event are presented. A data stream corresponding to a live event may be received. The data stream may comprise live video, wherein the live video comprises a live object. Input from a user may be received, wherein the input affects behavior of a virtual object. The live event augmented by the virtual object may be presented. The behavior of the live object of the live event may affect the behavior of the virtual object.

### CROSS REFERENCES

This non-provisional application claims priority to provisional application 61/478,416, entitled “Augmented Reality for Live Events,” filed Apr. 22, 2011, Atty. Docket No. 111526P1. This provisional application is hereby incorporated by reference in its entirety for all purposes.

### BACKGROUND

Live events, such as sporting events, provide entertainment for millions of people. Besides cheering (or jeering) from the stands, watching the live event on television or the internet, the opportunity for an observer (whether in-person or remotely) to involve himself or herself in the live event may be limited. Further, during some live events, periods of time elapse without much, if anything, occurring for an observer to view. For example, during the last few minutes of a close basketball game, frequent timeouts may be taken by each team in order to strategize. During these periods of time, the observer may be idly waiting for play to resume. Moreover, during some types of live events, the event may occur over a substantial period of time, with an observer possibly losing interest in the event.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system configured for augmenting presentation of a live event with one or more virtual objects.

FIG. 2 illustrates an embodiment of a presentation of a live event augmented with multiple virtual objects.

FIG. 3 illustrates an embodiment of a method for using augmented reality in conjunction with a live event.

FIG. 4 illustrates another embodiment of a method for using augmented reality in conjunction with a live event.

FIG. 5 illustrates an embodiment of a method for using augmented reality to present multiple virtual objects in conjunction with a live event.

FIG. 6 illustrates an embodiment of a method for presenting a virtual event based on a situation during a live event.

FIG. 7 illustrates another embodiment of a method for presenting a virtual event based on a situation during a live event.

FIG. 8 illustrates an embodiment of a method for presenting a virtual event based on the current situation in a live event.

FIG. 9 illustrates an embodiment of a computer system.

### SUMMARY

Various arrangements for using augmented reality in conjunction with a live event are presented. An example of method for using augmented reality may be presented. The method may include receiving, by a computerized device, a data stream corresponding to a live event, wherein the data stream comprises live video. The live video comprises a live object. The method may include receiving, by the computerized device, input from a user, wherein the input from the user affects behavior of a virtual object. The method may include presenting, by the computerized device, the live event augmented by the virtual object.

Embodiments of such a method may include one or more of the following: The virtual object may be presented such that the virtual object appears to compete with the live object. The behavior of the live object of the live event may affect the behavior of the virtual object. The live event may be a sporting event. The method may include receiving, by the computerized device, data corresponding to a second virtual object from a remote computerized device. The method may include displaying, by the computerized device, the live event augmented by the virtual object further augmented with the second virtual object. The behavior of the second virtual object is affected by a second user. The method may include modifying, by the computerized device, behavior of the virtual object in response to the second virtual object.

In another example of a method, for using augmented reality, the method may include receiving, by a computerized device, data corresponding to a live event. The method may include presenting, by the computerized device, the live event up to a point in time. The method may include presenting, by the computerized device, a virtual event at least partially based on an event that occurred during the live event earlier than the point in time. The method may include receiving, by the computerized device, input linked with the virtual event, wherein the input is received from a user. The method may include presenting, by the computerized device, an outcome of the virtual event, wherein the outcome is at least partially based on the input received from the user.

Embodiments of such a method may include one or more of the following: The virtual event may be presented at least starting when the live event is stopped. The live event may be a sporting event.

An example of a computer program residing on a non-transitory processor-readable medium and comprising processor-readable instructions may be presented. The processor-readable instructions may be configured to cause a processor to receive a data stream corresponding to a live event, wherein the data stream comprises live video. The live video may comprise a live object. The processor-readable instructions may be further configured to cause the processor to receive input from a user, wherein the input from the user affects behavior of a virtual object. The processor-readable instructions may be further configured to cause the processor to cause the live event augmented by the virtual object to be presented.

Embodiments of such a computer program may include one or more of the following: the virtual object may be presented such that the virtual object appears to compete with the live object. The behavior of the live object of the live event may affect the behavior of the virtual object. The live event may be a sporting event.

The processor-readable instructions may comprise additional processor-readable instructions configured to cause the processor to receive data corresponding to a second virtual object from a remote computerized device. The processor-readable instructions may comprise additional processor-readable instructions configured to cause the processor to cause the live event augmented by the virtual object further augmented with the second virtual object to be displayed. The behavior of the second virtual object may be affected by a second user. The processor-readable instructions may further comprise additional processor-readable instructions configured to cause the processor to adjust the behavior of the virtual object in response to the second virtual object.

An example of a computer program residing on a non-transitory processor-readable medium and comprising processor-readable instructions may be presented. The processor-readable instructions may be configured to cause a processor to receive data corresponding to a live event. The processor-readable instructions may be configured to cause the processor to presenting, by the computerized device, the live event up to a point in time. The processor-readable instructions may be configured to cause the processor to cause a virtual event to be presented at least partially based on an event that occurred during the live event earlier than the point in time. The processor-readable instructions may be configured to cause the processor to receive input linked with the virtual event. wherein the input is received from a user. The processor-readable instructions may be configured to cause the processor to cause to be presented an outcome of the virtual event, wherein the outcome is at least partially based on the input received from the user.

Embodiments of such a computer program may include one or more of the following: The virtual event may be at least started being presented when the live event is stopped. The live event may be a sporting event.

An example of an apparatus for using augmented reality may be presented. The apparatus may include means for receiving a data stream corresponding to a live event, wherein the data stream comprises live video. The live video may comprise a live object. The apparatus may include means for receiving input from a user, wherein the input from the user affects behavior of a virtual object. The apparatus may include means for causing the live event augmented by the virtual object to be presented.

Embodiments of such an apparatus may include one or more of the following: The virtual object may be caused to be presented such that the virtual object appears to compete with the live object. The behavior of the live object of the live event may affect the behavior of the virtual object. The live event is a sporting event. The apparatus may include means for receiving data corresponding to a second virtual object from a remote computerized device. The apparatus may include means for causing the live event augmented by the virtual object further augmented with the second virtual object to be displayed. The behavior of the second virtual object may be affected by a second user. The apparatus may include means for adjusting behavior of the virtual object in response to the second virtual object.

An example of an apparatus for using augmented reality may be presented. The apparatus may include means for receiving data corresponding to a live event. The apparatus may include means for causing the live event to be presented up to a point in time. The apparatus may include means for causing a virtual event at least partially based on an event that occurred during the live event earlier than the point in time to be presented. The apparatus may include means for receiving input linked with the virtual event, wherein the input is received from a user. The apparatus may include means for causing an outcome of the virtual event to be presented, wherein the outcome is at least partially based on the input received from the user.

Embodiments of such an apparatus may include one or more of the following: The virtual event may be at least started being presented when the live event is stopped. The live event may be a sporting event.

An example of a device for using augmented reality may be presented. The device may include a processor. The device may also include a memory communicatively coupled with and readable by the processor and having stored therein a series of processor-readable instructions. The processor readable instructions, when executed by the processor, cause the processor to receive a data stream corresponding to a live event, wherein the data stream comprises live video. The live video may comprise a live object. The processor readable instructions, when executed by the processor, may cause the processor to receive input from a user, wherein the input from the user affects behavior of a virtual object. The processor readable instructions, when executed by the processor, may cause the processor to cause the live event augmented by the virtual object to be presented.

Embodiments of such a device may include one or more of the following: The virtual object may be presented such that the virtual object appears to compete with the live object. The behavior of the live object of the live event may affect the behavior of the virtual object. The live event may be a sporting event. The series of processor-readable instructions which, when executed by the processor, may further cause the processor to receive data corresponding to a second virtual object from a remote computerized device. The series of processor-readable instructions which, when executed by the processor, may further cause the processor to cause the live event augmented by the virtual object further augmented with the second virtual object to be presented. The behavior of the second virtual object may be affected by a second user. The series of processor-readable instructions which, when executed by the processor, may further cause the processor to adjust the behavior of the virtual object in response to the second virtual object.

An example of a device for using augmented reality may be presented. The device may include a processor. The device may also include a memory communicatively coupled with and readable by the processor and having stored therein a series of processor-readable instructions. The processor-readable instructions, when executed by the processor, may cause the processor to receive data corresponding to a live event. The processor-readable instructions, when executed by the processor, may also cause the processor to cause the live event up to a point in time to be presented. The processor-readable instructions, when executed by the processor, may also cause the processor to cause a virtual event at least partially based on an event that occurred during the live event earlier than the point in time to be presented. The processor-readable instructions, when executed by the processor, may cause the processor to receive input linked with the virtual event, wherein the input is received from a user. The processor-readable instructions, when executed by the processor, may cause the processor to cause an outcome of the virtual event to be presented, wherein the outcome is at least partially based on the input received from the user.

Embodiments of such a device may include one or more of the following: The virtual event may be at least started being presented when the live event is stopped. The live event may be a sporting event.

### DETAILED DESCRIPTION

Live events, whether watched in person, such as from the stands at a sporting event, or via an electronic end user device, such as a television or mobile device (e.g., cellular phone, tablet computer) may, due to the nature of the live event, at times bore or frustrate the viewer. For example, during an American football game, it has been estimated that over the course of an entire game, the ball is only in play on the field for an average of eleven minutes. This eleven minutes of play is typically spread over a period of about three hours. As such, viewers of the game spend a significant amount of time watching the players mill about on the field, watching replays, and/or waiting idly for play to resume. During telecasts of such sporting events, time not involving game play may be filled with advertisements, replays, promotions for upcoming events, and banter between commentators. In other types of sporting events, such as basketball, tennis, golf, baseball, and hockey, similar downtime may be present. Other sporting events may be on-going for a significant amount of time (such as a car race), during which a person may desire a break from watching race cars circle a track.

Using augmented reality, various ways may exist for a user to “participate” in a live event. Generally, augmented reality refers to a presentation of a real world environment augmented with computer-generated data (such as sound, video, graphics or other data). In some embodiments, augmented reality, implemented in conjunction with a live event, may allow a user to control a virtual object that appears to compete or otherwise interact with the participants of the live event. For example, an end user device, such as a mobile phone, tablet computer, laptop computer, or gaming console may be used to present a live video feed of an event to a user. This live video feed may be video of an event that is occurring in real-time, meaning the live event is substantially concurrently with the presentation to the user (for example, buffering, processing, and transmission of the video feed may result in a delay anywhere from less than a second to several minutes). The presentation of the live event may be augmented to contain one or more virtual objects that can be at least partially controlled by the user. For instance, if the live event is a stock car race, the user may be able to drive a virtual car displayed on the end user device to simulate driving in the live event among the actual racers. As such, the user may be able to virtually “compete” against the other drivers in the race. The virtual object, in this example a car, may be of a similar size and shape to the real cars of the video feed. The user may be able to control the virtual car to race against the real cars present in the video feed. The real cars appearing in the video feed may affect the virtual object. For example, the virtual object may not be allowed to virtually move through a real car on the augmented display, rather the user may need to drive the virtual object around the real cars.

Besides racing, similar principles may be applied to other forms of live events; for example, track and field events (e.g., discus, running events, the hammer toss, pole vaulting), triathlons, motorbike events, monster truck racing, or any other form of event that a user could virtually participate in against the actual participants in the live event.

In some embodiments, a user may be able to virtually replay and participate in past portions of a live event. A user that is observing a live event may desire to attempt to retry an occurrence that happened during the live event. While viewing the live event, the user may be presented with or permitted to select an occurrence that happened in the course of the live event and replay it such that the user's input affects the outcome of at least that portion of the virtualized live event. Using a baseball game as an example, with runners on first and third, two outs, and the count being two balls and two strikes, the pitcher may throw a splitter, successfully striking out the batter with a pitch in the dirt. The inning may end and the game may continue. The user may desire to replay this unsuccessful at-bat with himself controlling the batter during the commercial break. As such, via an end user device, the user may be able to indicate the portion of the game he wishes to replay (e.g., the last at-bat). Game facts from the live event may be used to virtually recreate this at-bat for the user. For instance, the virtual game loaded by the user may use game facts leading up to the at-bat the user has selected. For instance, the opposing team, the stadium, the score, the time of day, the batter, the pitcher, and the sequence of pitches thrown by the pitcher may be used to provide the user with a virtual replay of at least that portion of the baseball game that the user can affect via input (e.g., swinging and aiming the virtual bat).

In replaying the selected portion of the live event, the entire event may be virtualized. As such, referring to the baseball example, the pitcher, stadium, field, fielders, batter, and ball may all be replaced by virtual objects, with one (or more) of the virtual objects, such as the batter, being controlled by the user. As such, this may resemble a video game instantiated with data from the live event. In some embodiments, a portion of the live event may involve a playback of a video feed of the live event with a virtual object that is controlled by the user being augmented. Referring again to the example of the baseball game, the pitcher, stadium, fielders, and field may be replayed from the video feed; the batter and/or ball may be virtualized. As such, the user may control the batter and swing at a virtual ball that has taken the place of the real ball present in the video feed.

Besides baseball, such reenactment of a portion of a live event may be applied to various forms of sporting events, such as football, soccer, tennis, golf, hockey, basketball, cricket, racing, skiing, gymnastics, and track and field events. Other forms of live events, besides sports, may also be reenacted using such techniques.

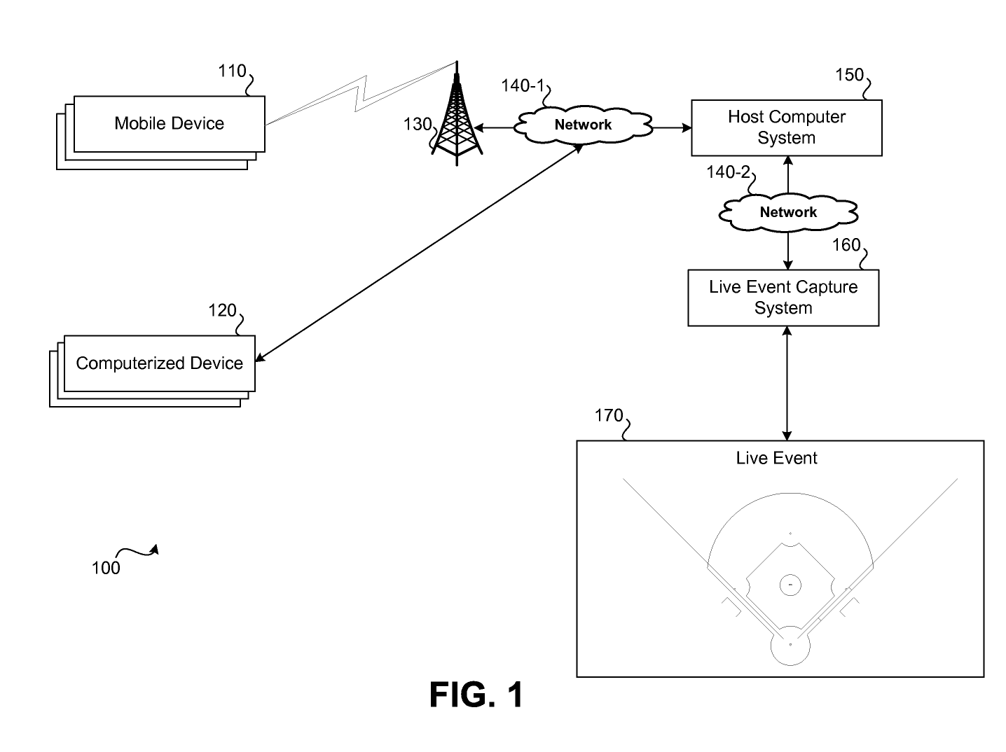

FIG. 1 illustrates an embodiment of a system 100 configured for augmenting presentation of a live event with one or more virtual objects. System 100 may also be used for reenacting a portion of a live event. System 100 may include mobile device 110, computerized device 120, wireless network 130, networks 140, host computer system 150, live event capture system 160, and live event 170. Live event 170 may be some form of event that may be observed by users live. For example, live event 170 may be a sporting event (e.g., baseball, (American) football, soccer, basketball, boxing, hockey, volleyball, surfing, biking, golf, Olympic events, tennis, bowling, etc.). Besides sporting events, other forms of live event 170 may also be possible, such as dancing competitions, operas, plays, and improvisational comedy shows.

Live event capture system 160 may be capable of capturing video, audio, and/or information about live event 170. For example, live event capture system 160 may include one or more video cameras, one or more microphones, and other electronic equipment that is configured to capture information about live event 170. Live event 170 may be a sporting event or some other form of event of which audio, video, and/or other data is captured while the live event is occurring. For example, referring to a sporting event, besides audio and/or video being captured, electronic equipment (possibly operated by a technician) may record information such as the name of the player at bat, the score, the count, the inning, the weather, etc. Live event capture system 160 may relay information about live event 170 in real-time (as it occurs) or in near real-time (within a short period of time of occurrence, such as a few seconds or a few minutes) to host computer system 150 via network 140-2. In some embodiments, host computer system 150 is local to live event capture system 160 and does not require network 140-2 for communication.

Network 140-2 may include one or more public and/or private networks. A public network, for example, may be the Internet, and a private network, for example, may be a corporate local area network and/or a satellite link. Network 140-2 may represent the same or a different network from network 140-1.

Host computer system 150 may receive audio, video, and/or other information about live event 170 from live event capture system 160. Host computer system 150 may process the information received from live event capture system 160. For example, processing may involve optimizing video and/or audio feeds for the various mobile devices and computerized devices that are part of system 100. Host computer system 150 may add information or process information received from live event capture system 160 to reduce the amount of processing necessary to be done by mobile devices and computerized devices of system 100. Host computer system 150 may add information to the video feed distributed to computerized device 120 and mobile device 110. For example, various objects within the video feed may be identified to not allow a virtual object to pass through. For example, in a stock car racing event, walls and cars may be identified as solid objects that prevent a virtual object controlled by a user from passing through. Host computer system 150 may identify various points within a live event that are permitted to be replayed. A fully or partially virtualized replay of one or more of these portions of the live event may be transmitted to mobile device 110 and/or computerized device 120 to allow users to replay the portions of the live event. Host computer system 150 may distribute video, audio, and/or other information to mobile devices and/or computerized devices that are part of system 100. Host computer system 150 may communicate with various mobile devices and/or computerized devices via network 140-1.

Network 140-1 may include one or more public and/or private networks. A public network, for example, may be the Internet, and a private network, for example, may be a corporate local area network and/or a satellite link.

One or more mobile devices may communicate with host computer system 150 via a wireless network, such as wireless network 130. For simplicity, only one mobile device is illustrated: mobile device 110. Mobile device 110 may be a device such as a cellular phone (e.g., a smartphone), tablet computer, laptop computer, or handheld gaming device. One or more computerized devices may communicate with host computer system 150 via network 140-1. For simplicity, only one computerized device is illustrated: computerized device 120. Computerized device 120 may be a desktop computer, gaming console, television, internet-enabled television, etc. Mobile devices and computerized devices are collectively referred to as “end user devices.”

For each type of end user device, it may be possible to receive data from and transmit data to host computer system 150 and/or other mobile devices and computerized devices. For example, a user of an end user device may be able to request a replay of a particular portion of a live event. The host computer system 150 may receive this request, at least partially process data as necessary to permit the replay, and transmit the data to the requesting end user device. In some embodiments, such as where an end user is controlling a virtual object that is augmented into a live event, multiple other virtual objects which may be controlled either by the device or by another user may also augment the display of the live event. As such, a live event may be presented to a user on an end user device, with the live event being augmented by a virtual object controlled by the user and one or more additional virtual objects controlled by users via other end user devices. As such, a user may “compete” with real objects in the live event and other users simultaneously.

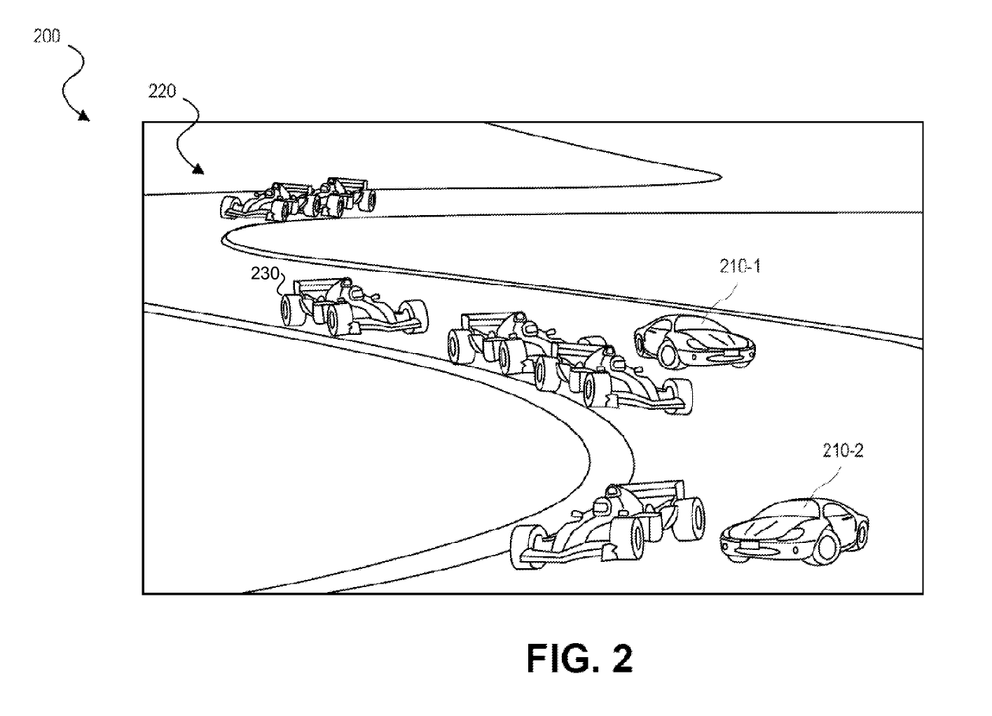

FIG. 2 illustrates an embodiment 200 of a presentation of a live event augmented with multiple virtual objects. As such, augmented reality is used to augment a display of the live event with one or more virtual objects. FIG. 2 illustrates an example of a video feed of a live event (a race) being augmented on an end user device with multiple virtual objects. In this instance, each virtual object is a car. The display of FIG. 2 may be presented by an end user device such as an end user device of FIG. 1, based on a live event. The end user device displays real-time or near real-time video 220 (and, possibly, corresponding audio) of the race. The user can “participate” in the live event by controlling a virtual object, such virtual object 210-1, a virtual car, via the end user device. Control of the virtual objects, of course, has no outcome on the live event or the live objects within the live event (such as on real car 230); however, the user may be presented with the opportunity to try to “compete” against participants (such as real car 230) in the live event via the augmented reality display on the end user device. Virtual object 210-2 may be controlled by the end user device or may be controlled by another user (possibly via a different end user device).

In FIG. 2, two virtual objects are present: virtual object 210-1 and virtual object 210-2, each are virtual cars. Via controls on the end user device, the user may be able to control virtual object 210-1. For instance, left and right arrow keys on the end user device may allow the user to steer virtual object 210-1. Other keys may serve to accelerate and brake virtual object 210-1. As such, virtual object 210-1 may be controlled by the user and displayed as an overlay on the video and/or audio feed of the live event. Virtual object 210-1 may be given properties that enable it to fairly compete with the vehicles present in the displayed live event. For instance, the turning, acceleration, and braking characteristics of virtual object 210-1 may be similar to the vehicles in the live event such that the user can fairly “compete” with the live vehicles via the end user device.

Virtual object 210-2 may be controlled by some other user that is remotely located from the user. As such, the user competes against the participants in the live event and other users controlling virtual objects. While FIG. 2 illustrates two virtual objects 210, this is for example purposes only: one virtual object may be present or more than two virtual objects may be present.

The race as illustrated in FIG. 2 is intended only as an example. Allowing a user to participate in a live event via an end user device by augmenting a presentation of the live event with one or more virtual objects may be applied to other forms of live events. For example, in a live event such as shot-put, the user may take a turn at throwing a shot-put to compare his best effort with persons participating the live event.

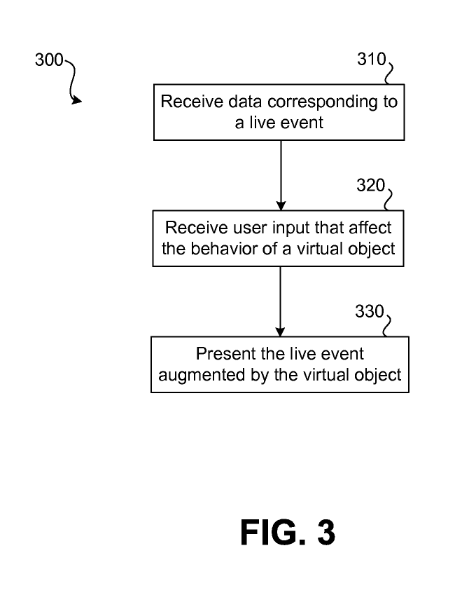

System 100 of FIG. 1 may be used to perform various methods for presenting a live event augmented by input received from a user, such as presented in FIG. 2. FIG. 3 illustrates an embodiment of a method 300 for a presentation of a live event augmented with a virtual object at least partially controlled by a user. Each step of method 300 may be performed by a computer system, such as host computer system 150 of FIG. 1. Method 300 may be performed using a system, such as system 100 of FIG. 1 or some other system configured for presenting a live event augmented by a virtual object partially controlled by a user.

At step 310, a data stream of a live event may be captured. The data stream may contain audio, video, and/or other information. A live event capture system, such as live event capture system 160 of system 100 of FIG. 1, may be used to capture some or all of the live event. In some embodiments, one or more cameras and, possibly, microphones may be used to capture a live event. Step 310 may include the data stream being transmitted in real-time or near real-time to a host computer system. The host computer system may receive and process video, audio, and/or other information received from the live capture system. For example, the host computer system may identify various objects (e.g., cars, walls, roads, balls) within images of the live event and augment such objects with data. For example, a wall within an image captured of a live event may be augmented with data such that a user controlled object, such as a virtual car, cannot travel through the wall. Means for capturing the data stream of the live event may include one or more computer systems. Such one or more computer system may be communicatively coupled with one or more cameras and/or microphones.

At step 320, user input may be received that affects the behavior of a virtual object. The user input may initially be received by an end user device being operated by the user. The user input may be transmitted to the host computer system. As such, presentation of a virtual object to the user via the end user device may be affected by the user input received by the host computer system via the end user device. As an example of this, consider FIG. 2. In FIG. 2, a user may provide input to a mobile device to control virtual object 210-1. This input may include a user pressing buttons on the end user device (or by providing some other form of input, such as by physically moving the end user device) so that the car responds to steering, acceleration, and braking of virtual object 210-1. Indication of the user input may be transmitted to the host computer system. Means for receiving user input may include one or more computer systems.

In some embodiments, rather than the user input that affects the behavior of the virtual object being transmitted to the host computer system, the user input may be used locally by the mobile device to affect the behavior of the virtual object. Returning to the example of FIG. 2, if the user presses a button to indicate virtual object 210-1 should steer to the left, the behavior of the virtual object may be affected such that it steers to the left.

At step 330, the end user device may present the user with the live event augmented by the input received from the user. For example, referring to FIG. 2, a real-time or near real-time display of a race may be provided to the user via the end user device. The display of the race may be augmented with virtual object 210-1, the behavior of which is affected by input received from the user. As such, in the example of FIG. 2, the user can virtually participate in the live event via the end user device. At step 330, presentation of the live event augmented by the virtual object may include transmitting by the host computer system to the end user device images and/or audio of the live event that have been augmented with images of the virtual object and/or sounds related to the virtual object. In some embodiments, augmenting the video and audio of the live event occurs at the mobile device without data relating to the user input needing to be transmitted to the host computer system. Means for presenting the user with the live event augmented with input received from the user may include one or more computer systems.

Step 330 may comprise some amount of processing by the end user device in order to present the live vent augmented with a virtual object that is controlled by the user. For example, based on the data received related to the live event, the virtual object displayed by the mobile device may be required to behave according to various rules. For example, the virtual object may not be able to pass through objects, such as walls, cars, or barriers present in the live event. Movement (and/or other actions) of the virtual object may be controlled by the end user device, such as a speed, turning ability, stopping ability, and reaction to the presence of other virtual and/or real objects (of the live event). The behavior of the virtual object may be controlled by the end user device such that the virtual object can compete fairly with objects in the live event, such as by having a similar acceleration and top speed. Rules that govern how the virtual object is permitted to behave may be received in conjunction with the live event. As such, how the user is permitted to control the virtual object may be defined by rules received from a remote host computer system. Such rules may define characteristics of the virtual object, such as how the virtual object can move, how fast, where, and when.

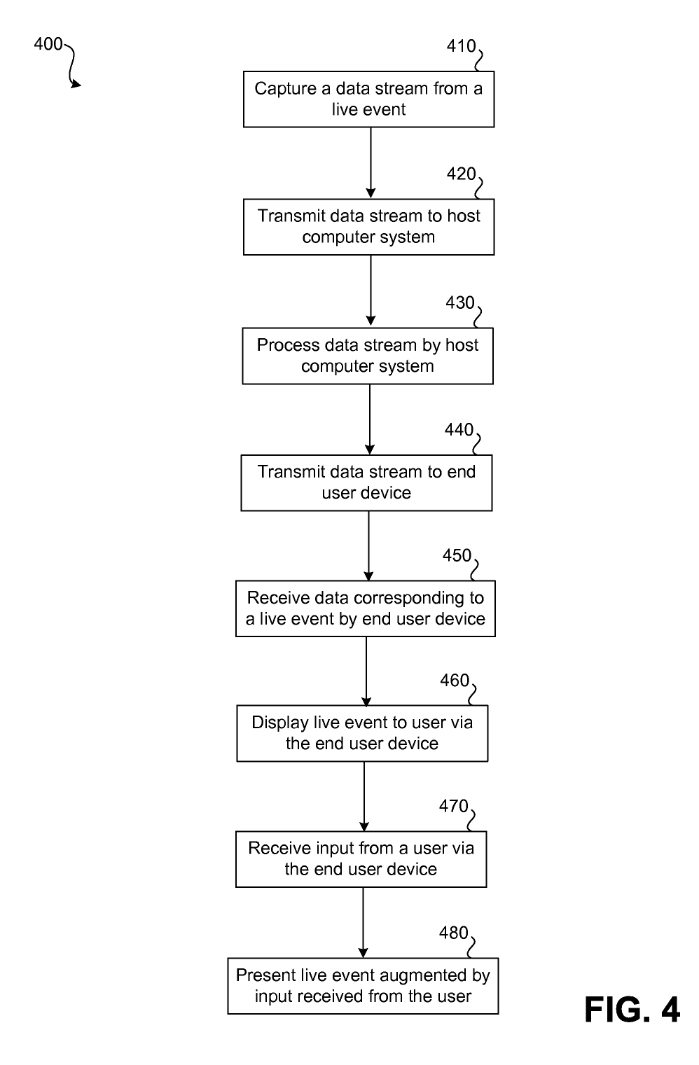

FIG. 4 illustrates another embodiment of a method 400 for using augmented reality in conjunction with a live event. Each step of method 400 may be performed by a computer system. Method 400 may be performed using a system, such as system 100 of FIG. 1 or some other system for presenting a live event augmented by input received from a user.

At step 410, a data stream of a live event may be captured (e.g., received). The data stream may contain audio, video, and/or other information. A live event capture system, such as live event capture system 160 of system 100 of FIG. 1, may be used to capture some or all of the live event. Means for performing step 410 include one or more cameras and/or microphones. At step 420 the data stream captured at step 410 may be transmitted in real-time or near real-time to a host computer system. Means for receiving the data stream include one or more computer systems.

At step 430, the host computer system may process video, audio, and/or other information received from the live capture system. For example, the host computer system may identify various objects (e.g., cars, walls, roads, balls) within images of the live event and augment such objects with data. For example, a wall within an image captured of a live event may be augmented with data such that a user-controlled object, such as a virtual car, cannot appear to travel through the wall. The host computer system may process the data stream received in real-time or near real-time. This may involve some level of pre-processing to reduce the amount of processing necessary at the end user devices for the live feed to be augmented with a virtual object controlled by the user. Further, the host computer system may add additional data to the data stream and/or may compress the data stream being sent to the one or more end user devices. The processing of step 430 may occur in real-time or near real-time. Means for performing step 430 include one or more computer systems.

At step 440, the data stream may be transmitted to one or more end user devices. For example, mobile device 110 and computerized device 120 may be examples of the end user devices. As such, the data stream of the live event processed by the host computer system may be transmitted to multiple end user devices. Means for performing step 440 include one or more computer systems. At step 450, data corresponding to the live event may be received by one or more end user devices. The data received by each end user device may be data processed by the host computer system at step 430. Means for performing step 450 include an end user device, such as a mobile phone (e.g., a smart phone) or a gaming device.

At step 460, the live event may be displayed to the user via the end user device. This may involve the live event being displayed to the user in real-time or near real-time. The display of the live event to the user via the end user device at step 460 may be augmented with one or more virtual objects, the behavior of which may be affected by input received from the user. Other virtual objects present on the display of the live event may be controlled by the end user device, the host computer system, or users of other end user devices. For example, a virtual object controlled by a first user on a first end user device may also be displayed to a second user on a second end user device. As such, the user may view a virtual object controlled by him and an additional virtual object controlled by another user. Means for performing step 460 include an end user device.

At step 470, a user may provide input to the end user device. The input may control (or at least affect the behavior of) a virtual object displayed by the end user device. The input may allow the user to virtually compete against persons or objects that are part of the live event displayed by the end user device. The virtual object controlled by the end user may be affected by the behavior of the persons or objects in the live event. However, the persons or objects in the live event are not affected by the actions of the virtual object. The behavior of virtual objects controlled by other users may or may not be affected by the behavior of the virtual object controlled by the user. Means for performing step 470 include an end user device.

At step 480, the end user device may present the user with the live event augmented by the one or more virtual objects. For example, referring to FIG. 2, a real-time or near real-time display of a race may be provided to the user via the end user device. A virtual car may be controlled by the user via the user input provided at step 470. As such, the user can virtually “participate” in the live event via the end user device against the participants in the live event. Means for performing step 480 include an end user device. More specifically, a display and/or speaker of the end user device may be used to perform step 480.

Step 480 may comprise processing by the end user device in order to present the live vent augmented with a virtual object that is controlled by the user. For example, based on the data received related to the live event, the virtual object displayed by the mobile device may be required to behave according to various rules. For example, the virtual object may not be able to pass through objects, such as walls, cars, or barriers present in the live event. Movement (and/or other actions) of the virtual object may be controlled by the end user device, such as a speed, turning ability, stopping ability, and reaction to the presence of other virtual and/or real objects (of the live event). The behavior of the virtual object may be controlled by the end user device such that the virtual object can compete fairly with objects in the live event, such as by having a similar acceleration and top speed. Rules that govern how the virtual object is permitted to behave may be received in conjunction with the live event. As such, how the user is permitted to control the virtual object may be defined by rules received from a remote host computer system. Such rules may define characteristics of the virtual object, such as how the virtual object can move, how fast, where, and when. The rules that define how the virtual object is permitted to behave may vary based on the type of live event. For example, rules for a virtual object representing a car may be different from rules for a virtual object representing a golfer.

Method 400 may include a continuous or near continuous stream of data related to the live event being displayed to the user via the end user device. The end user may continue to provide additional input that affects one or more virtual objects that augment the display of the live event by the end user device. As such, while the user is viewing the live event using the end user device, the user may also be controlling a virtual object that augments the display of the live event and appears to interact with objects and/or persons present within the live event.

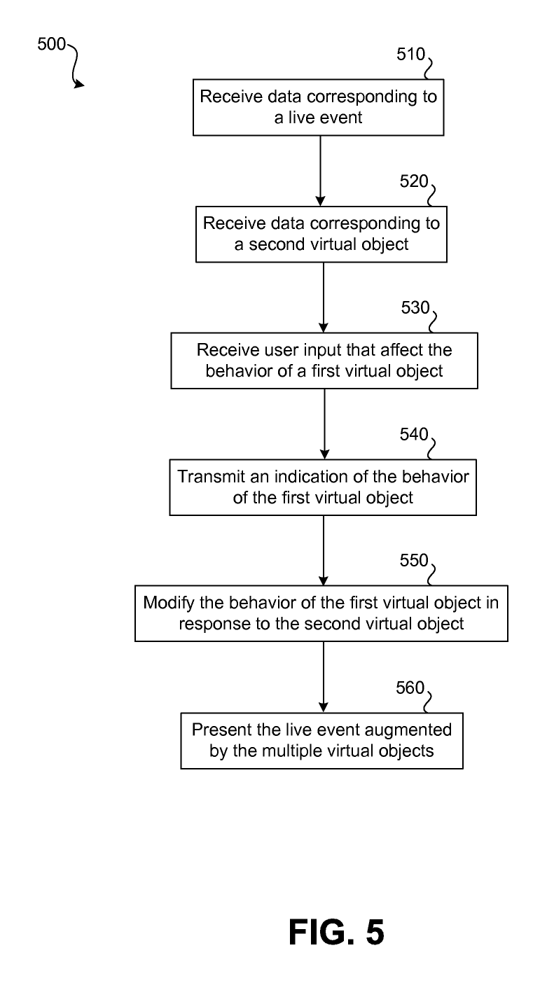

FIG. 5 illustrates an embodiment of a method 500 for using augmented reality to present multiple virtual objects in conjunction with a live event. Each step of method 500 may be performed by an end user device, such as mobile device 110 or computerized device 120 of FIG. 1.

At step 510, data corresponding to the live event may be received by an end user device from a host computer system. The data may include video and/or audio information that corresponds to a live event in real-time or near real-time. (As such, data that corresponds to the live event is received by the mobile device substantially while the live event is occurring.)

At step 520, data corresponding to a second virtual object may be received by the mobile device. The first virtual object may be controlled by a user of the mobile device. The second virtual object may be controlled by another user that controls the second virtual object using a second end user device. Based on input the second user has provided to the second end user device, the behavior of the second virtual object presented to the end user may be affected.

At step 530, user input that affects the behavior of the first virtual object may be received from the user. The input may control (or at least affect the behavior of) a virtual object displayed by the end user device. The input may allow the user to virtually compete against persons or objects that are part of the live event displayed via the end user device. The virtual object controlled by the end user may be affected by the behavior of the persons or objects in the live event. However, the persons or objects in the live event are not affected by the actions of the virtual object. Therefore, the first virtual object may appear to be competing with one or more objects and/or persons of the live event and/or may compete with the second virtual object controlled by the second user. The first virtual object and the second virtual object may interact with each other. As such, input provided by the first user may affect the behavior of the second virtual object that is controlled by the second user. As an example of this, the first virtual object and the second virtual object may be race cars. If the first user drives the first virtual object into the second virtual object, the second virtual object's behavior may change due to a collision between the virtual objects.

An indication of the behavior of the first virtual object may be transmitted by the end user device at step 540. The indication of the behavior of the first virtual object may be transmitted to a host computer system and/or to the end user device being utilized by the second user that is controlling the second virtual object. In some embodiments, the host computer system may transmit an indication of the behavior of the first virtual object to the second end user device.

At step 550, the behavior of the first virtual object may be modified in response to the second virtual object. As such, the second virtual object can interact with the first virtual object. As detailed earlier, one example may involve the second virtual object impacting the first virtual object and thus changing a velocity and direction of the first virtual object.

At step 560, the end user device may present the user with the live event augmented by the first and second virtual objects. For example, referring to FIG. 2, a real-time or near real-time display of a race may be provided to the user via the end user device with virtual objects 210-1 and 210-2. An augmented reality car may be controlled by the user via the user input provided at step 470. As such, the user can virtually participate in the live event via the end user device. Virtual object 210-2 may be controlled by a second user and displayed by the end user device. As such, the user may simultaneously “compete” with objects and/or persons in the live event and compete with virtual objects controlled by other users. While method 500 discusses two users and two virtual objects, the number of virtual objects and users may vary in other embodiments of method 500.

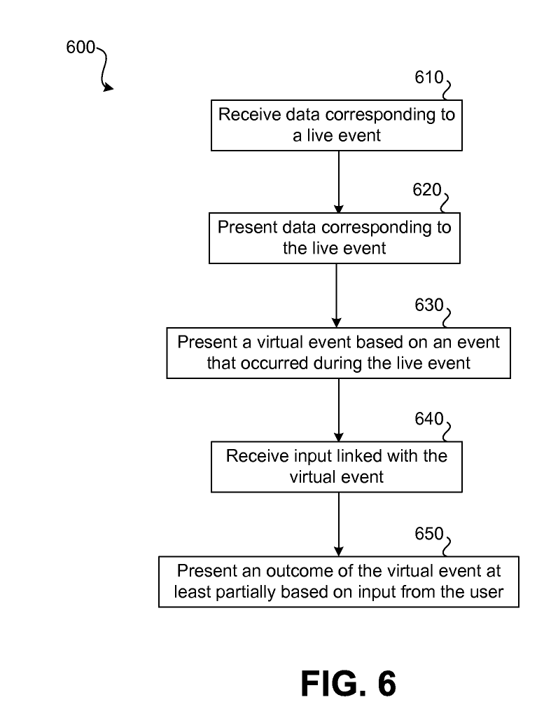

FIG. 6 illustrates an embodiment of a method for a virtual event based on a situation that occurred during a live event. Method 600 may be performed by a system, such as system 100 of FIG. 1. Each step of method 600 may be performed by a computer system, such as an end user device. Method 600 may be performed using a system, such as system 100 of FIG. 1, or some other system for presenting a live event augmented by input received from a user. Method 600 may be applied to a variety of live events, including sporting events such as basketball, golf, tennis, football, soccer, and hockey.

An example of when method 600 may be used is a situation where a participant in a live event performs a poor play or does not perform well in a play crucial to the outcome of the live event. For example, if a golfer in a live event hits a ball into a sand trap, a user's reaction may be “I can do better!” The user may be able to bookmark that shot for later replay or may be able to immediately replay the shot in a virtualized environment on an end user device. Contextual data related to the occurrence, in this case a golf shot, to be replayed may be transferred to the end user device, such as the location of the shot on the course, the wind direction and speed, statistics of the live player and the player's round, the live player's strength and tendencies (e.g., hook, slice, shank), the score of the live player's round and his competitors' rounds up to the point of the round where the replay occurs, an indication of the live player's shot, etc. The user may then try to better the live player's shot and, possibly, complete the remainder of the live player's round in the virtualized environment.

As another example, consider (American) football. A user may not agree with a coaching decision, such as a coach having called three running plays in a row. As such, the user may take his turn at virtual play calling and/or controlling a virtualized player during some down series that occurred in the live game. The user may indicate the downs that the user wishes to replay. Contextual data related to that point in the football game may be sent to the end user device, such as indications of the live players on the field, the position on the ball on the field, the score, the time remaining, the number of timeouts remaining, the wind speed and direction, stadium information, weather and time of day information, injury information, and/or what occurred during those plays in the live event. The user may then select different (or the same) plays to be called in the virtualized game on the end user device. The user may also control one or more players in the virtualized game, such as the quarterback. As such, the user may get the satisfaction of having called a more successful series of downs (e.g., he gets the first down whereas the team in the live event went three and out), or may have the dissatisfaction of having called an even less successful series of downs (e.g., his input results in an interception).

At step 610 of method 600, a data stream of a live event may be captured. The data stream may contain audio, video, and/or other information. A live event capture system, such as live event capture system 160 of system 100 of FIG. 1, may be used to capture some or all of the live event. The data stream captured at step 610 may be transmitted in real-time or near real-time to a host computer system. The host computer system may process video, audio, and/or other information received from the live capture system. For example, the host computer system may identify various objects (e.g., cars, walls, roads, balls) within images of the live event and augment such objects with data. The host computer system may process the data stream received in real-time or near real-time. This may involve some level of pre-processing to reduce the amount of processing necessary at the end user devices for the live feed to be augmented with a virtual object controlled by the user. Further, the host computer system may add additional data to the data stream and/or may compress the data stream being sent to the one or more end user devices. The processing may occur in real-time or near real-time. At step 610, the data corresponding to the live event may be received by an end user device from the host computer system. At step 620, the data corresponding to the live event may be presented by the end user device to a user.

At step 630, a virtual event based on the replay of at least a portion of the live event may be presented to the user. For example, following a golf shot by a player occurring in the live event, the user may be presented the opportunity to virtually retry the shot. As such, the user may be presented with a virtualized golf hole and conditions that correspond to the live event. The virtual event may be fully virtual. In a fully virtual event, the user may, for example, be presented with a virtual rendering of a golf hole and a virtualized player and golf ball. In other embodiments, the event may be only partially virtual, that is actual images from the live event may be used of the course and/or golf player, and only some objects, such as the ball, may be virtualized.

At step 640, input may be received from a user that affects the outcome of the virtual event. For example, if the virtual event is the replay of a golf shot, the input received from the user may be used to determine the club selection, aim, and swing of the player in the virtual event. At step 650, the user may be presented with an outcome of the virtual event that is at least partially based on the user input. Again, returning to the example of the replayed golf shot, the user may be able to view the results of the virtualized swing, aim, and club selection and compare it to the shot by the live player. In some embodiments, the user may be permitted to complete the remainder of the virtualized live event (e.g., the remaining holes) via the end user device.

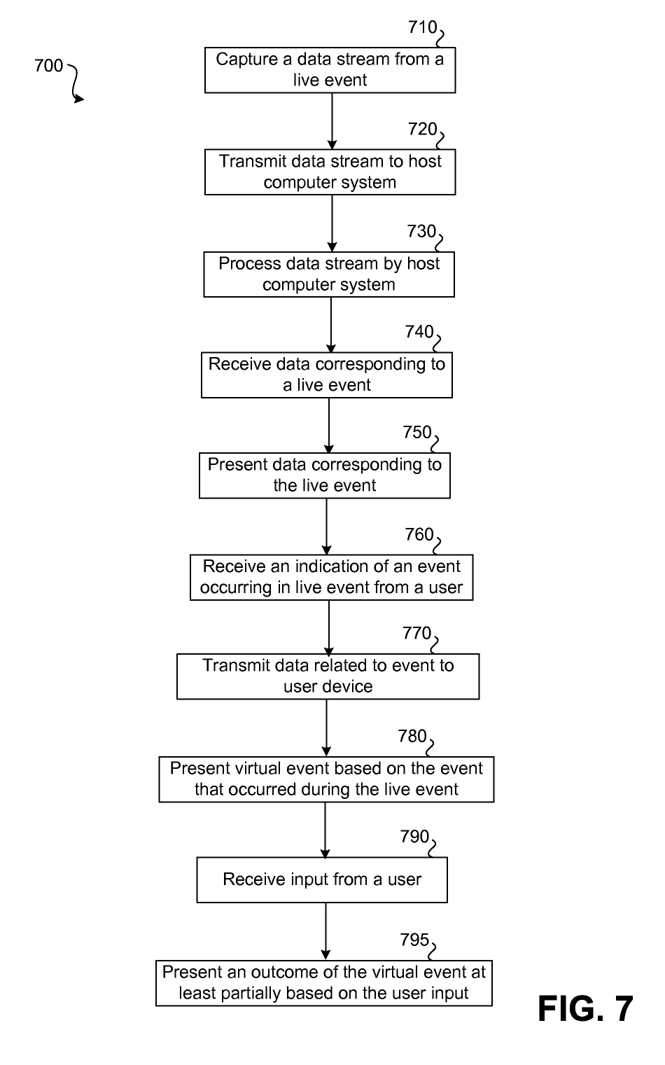

FIG. 7 illustrates another embodiment of a method for presenting a virtual event based on a situation that occurred during a live event. Method 700 may be performed by a system, such as system 100 of FIG. 1. Each step of method 700 may be performed by computer systems. Method 700 may be performed using a system, such as system 100 of FIG. 1 or some other system for presenting a live event augmented by input received from a user. Method 700 may be applied to a variety of live events, including sporting events such as basketball, golf, tennis, football, soccer, and hockey. For instance, some or all of method 700 may be performed at a time when the live event is stopped, such as a timeout, commercial break, or delay of game.

At step 710 of method 700, a data stream of a live event may be captured. The data stream may contain audio, video, and/or other information. A live event capture system, such as live event capture system 160 of system 100 of FIG. 1, may be used to capture some or all of the live event. The data stream captured at step 710 may be transmitted in real-time or near real-time to a host computer system at step 720.

At step 730, a host computer system, such as host computer system 150 of FIG. 1, may serve as the host computer system. The host computer system may process the data stream received in real-time or near real-time. This may involve some level of pre-processing to reduce the amount of processing necessary at the end user device for the live feed to be augmented with a virtual object controlled by the user. Further, the host computer system may add additional data to the data stream and/or may compress the data stream being sent to the one or more end user devices. The processing of step 730 may occur in real-time or near real-time. In some embodiments of method 700, no audio and/or video of the live event may be transmitted to the end user device. Rather, when the user wishes to “take over” a live event, data related to the current point in time of the live event may be transmitted to the end user device of the user.

At step 740, data corresponding to the live event up to approximately the current point in time may be received by one or more end user devices. For example, mobile device 110 and computerized device 120 may be examples of the end user devices. At step 750, the user may be presented with data corresponding to the live event.

At step 760, an indication of the event that occurred during the live event that the user desires to replay may be received from the user by the end user device. The end user device may transmit the indication to the host computer system. For example, during the live event, the user may bookmark various points in the live event that he may want to replay at a future time. At the future time, he may select a play that he desires to replay. In some embodiments, the user is presented with a predefined list of plays that are available for replay.

At step 770, data related to the event that the user desires to replay may be transmitted to the end user device. This information may be specific to the event being replayed. For example, as a generic sporting example, the score, players on the field, physical location of the ball, and time left in the game may be transmitted to the end user device. As those familiar with sports will understand, many other variables related to a particular event may be specific to the sport and may be transmitted to the end user device.

At step 780, a virtual event based on the replay of a portion of the live event may be presented to the user. The replayed portion of the event may be completely or partially virtual. For example, a partially virtual event may include images of the actual location where the live event is occurring. At step 790, input may be received from the user that affects the outcome of the virtual event. For example, if the virtual event is the replay of a golf shot, the input received from the user may be used to determine the club selection, aim, and swing of the player in the virtual event. At step 795, the user may be presented with an outcome of the virtual event that is at least partially based on the user input. Again, returning to the example of the replayed golf shot, the user may be able to view the results of the virtualized swing, aim, and club selection and compare it to the shot by the live player. In some embodiments, the user may be permitted to complete the remainder of the virtualized live event via the end user device.

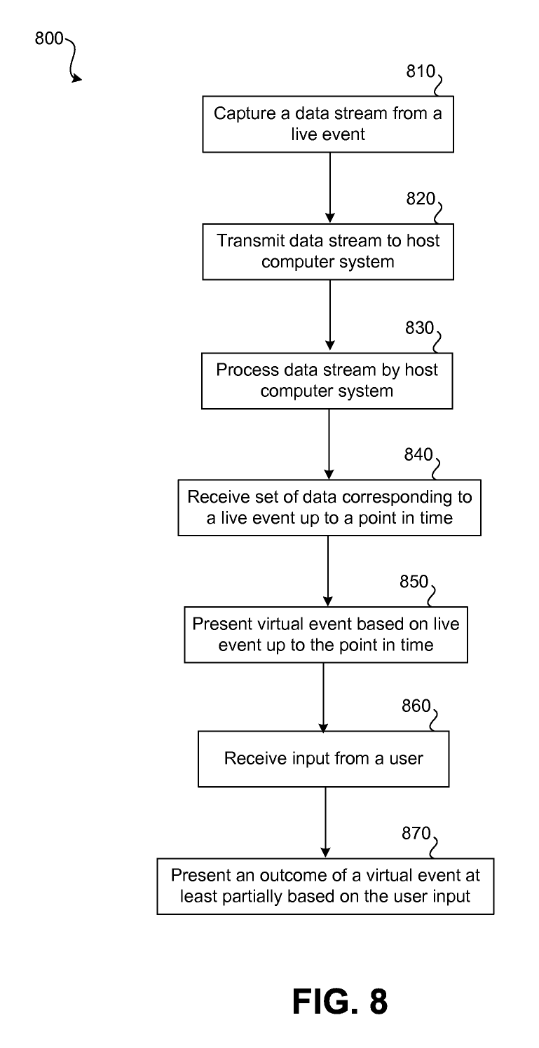

FIG. 8 illustrates an embodiment of a method 800 for a virtual event based on a live event performed up through a point in time. Method 800 may be performed by a system, such as system 100 of FIG. 1. Method 800 may be applied to a variety of live events, including sporting events such as basketball, golf, tennis, football, soccer, and hockey.

An example of a situation in which method 800 may be used is if a user wishes to “take over” a live event while there is a break in the action of the live event. Sporting events typically have various breaks in the action, such as the end of innings, halftime, timeouts, television timeouts, injury timeouts, etc. During one of these breaks (or at some other point), while the user is perhaps idle waiting for the live event to resume, the user can assume control of a virtualized version of the live event via an end user device. As an example, if the live event is a basketball game and the game is currently stopped due to a timeout, the user may, according to an embodiment of method 800, continue playing the game. Various data from the live game may be used to recreate the live event up until approximately the current point in the live event on the end user device. For example, for the basketball game, the user may be presented with a virtualized version of the live event that has the same score, same players on the court, same amount of timeouts remaining, same foul count, same arena, same team having possession of the ball, etc. From this point, the user may be able to participate in the virtualized version of the game and try for a favorable outcome.

As another example, consider golf. If a live player the user is tracking has just completed the 15th hole, the user may want to try to play the 16th hole before the live player does (or at least starts to). As such, the user may be presented with a virtualized version of the 16th hole of the course the live player is playing on. The foursome the live player is part of may be virtually recreated. The live player's score and other live players' scores from the tournament may be used to provide the virtualized context for the game being played by the user. The user may then play the 16th hole (and, possibly, if desired, the remaining holes of the course). This may be especially entertaining in that the user could see how his strategy matches up with the strategy employed by the live player. (For example, if the 16th hole is a par 5, the user may try to go for the green in two shots, while the live player may lay up on the second shot and have a short wedge into the green.) Similar examples exist for numerous other sports, such as baseball, football, tennis, boxing, and hockey.

At step 810 of method 800, a data stream of a live event may be captured. The data stream may contain audio, video, and/or other information. A live event capture system, such as live event capture system 160 of system 100 of FIG. 1, may be used to capture some or all of the live event. The data stream captured at step 810 may be transmitted in real-time or near real-time to a host computer system at step 820.

At step 830 a host computer system, such as host computer system 150 of FIG. 1, may serve as the host computer system. The host computer system may process the data stream received in real-time or near real-time. This may involve some level of pre-processing to reduce the amount of processing necessary at the end user devices for the live feed to be augmented with a virtual object controlled by the user. Further, the host computer system may add additional data to the data stream and/or may compress the data stream being sent to the one or more end user devices. The processing of step 830 may occur in real-time or near real-time. In some embodiments of method 800, no audio and/or video of the live event may be transmitted to the end user device. Rather, when the user wishes to “take over” a live event, data related to the current point in time of the live event may be transmitted to the end user device of the user.

At step 840, data corresponding to the live event up to approximately the current point in time may be received by one or more end user devices. For example, mobile device 110 and computerized device 120 may be examples of the end user devices. At step 850, the user may be presented with a virtualized version of the live event that is in the context of the live event up to approximately the current point in time. For example, if the data stream captured at step 810 is indicating that it is the end of the fourth inning in a baseball game, the virtual event presented to the user at step 850 may be the top of the fifth inning

At step 860, input may be received by the end user device from the user. This input may be used to at least partially control the virtualized version of the live event after the point in time. For example, returning to the example of the baseball game, in the top of the fifth inning, the user may control the pitcher. At step 870, an outcome of the virtual event that is at least partially based on the user's input is provided to the user via the end user device. Again referring to the example of the baseball game, the user may receive feedback as to whether a pitch was a strike, a hit, a ball, or a wild pitch. User input may continue to be received and the remainder of the inning or game may be simulated based at least in part on the live event up to the point in time received by the end user device at step 840 and the user's input received at step 860.

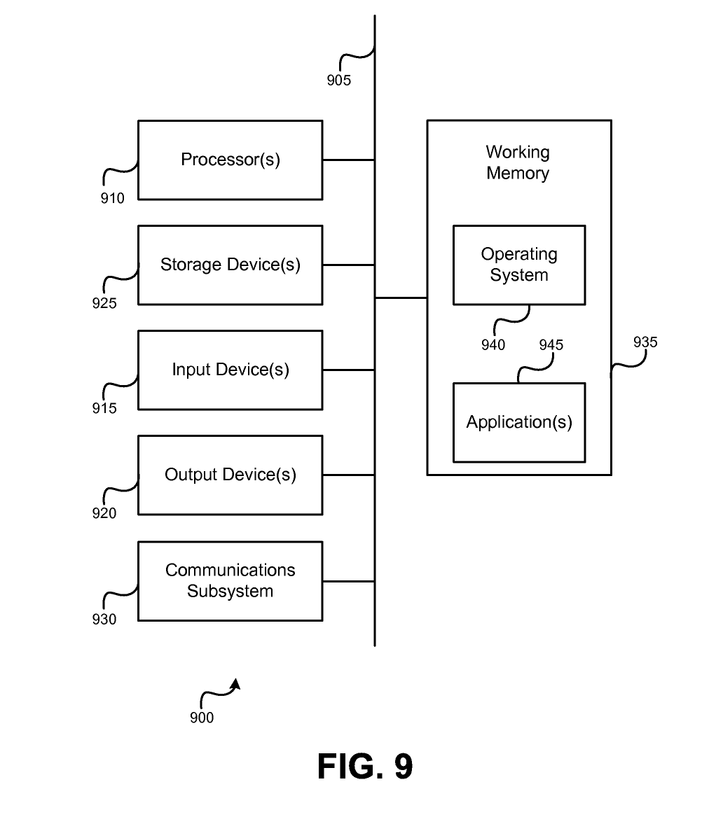

A computer system as illustrated in FIG. 9 may be incorporated as part of the previously described computerized devices. For example, computer system 900 can represent some of the components of the mobile devices, host computer system, live event capture system, and/or the computerized devices discussed in this application. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a mouse, a keyboard, and/or the like; and one or more output devices 920, which can include without limitation a display device, a printer, and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the computer system 900 will further comprise a working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as the system 900. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take the form of a non-volatile media or volatile media. Non-volatile media include, for example, optical and/or magnetic disks, such as the storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 905 retrieves and executes the instructions. The instructions received by the working memory 935 may optionally be stored on a storage device 925 either before or after execution by the processor(s) 910.

The methods, systems, and devices discussed above are examples. Various configurations may omit, substitute, or add various procedures or components as appropriate.

For instance, in alternative configurations, the methods may be performed in an order different from that described, and/or various steps may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for using augmented reality, the method comprising:
receiving, by a computerized device, a data stream corresponding to a live event, wherein the data stream comprises live video, wherein:
the live video comprises a live object;
receiving, by the computerized device, input from a user, wherein the input from the user affects behavior of a virtual object; and
presenting, by the computerized device, the live event augmented by the virtual object, wherein a behavior of the live object of the live event affects the behavior of the virtual object.

2. The method for using augmented reality of claim 1, wherein:
the virtual object is presented such that the virtual object appears to compete with the live object.

3. The method for using augmented reality of claim 1, wherein the live event is a sporting event.

4. The method for using augmented reality of claim 1, further comprising:
receiving, by the computerized device, data corresponding to a second virtual object from a remote computerized device; and
displaying, by the computerized device, the live event augmented by the virtual object further augmented with the second virtual object.

5. The method for using augmented reality of claim 4, wherein the behavior of the second virtual object is affected by a second user.

6. The method for using augmented reality of claim 4, further comprising:
modifying, by the computerized device, behavior of the virtual object in response to the second virtual object.

7. A method for using augmented reality, the method comprising:
receiving, by a computerized device, data corresponding to a live event;
presenting, by the computerized device, the live event up to a point in time;
presenting, by the computerized device, a virtual event at least partially based on an event that occurred during the live event earlier than the point in time;
receiving, by the computerized device, input linked with the virtual event, wherein the input is received from a user; and
presenting, by the computerized device, an outcome of the virtual event, wherein the outcome is at least partially based on the input received from the user.

8. The method for using augmented reality of claim 7, wherein:
the virtual event is presented at least starting when the live event is stopped.

9. The method of claim 7, wherein the live event is a sporting event.

10. A computer program residing on a non-transitory processor-readable medium and comprising processor-readable instructions configured to cause a processor to:
receive a data stream corresponding to a live event, wherein the data stream comprises live video, wherein:
the live video comprises a live object;
receive input from a user, wherein the input from the user affects behavior of a virtual object; and
cause the live event augmented by the virtual object to be presented, wherein a behavior of the live object of the live event affects the behavior of the virtual object.

11. The computer program of claim 10, wherein:
the virtual object is presented such that the virtual object appears to compete with the live object.

12. The computer program of claim 10, wherein the live event is a sporting event.

13. The computer program of claim 10, wherein the processor-readable instructions further comprise additional processor-readable instructions configured to cause the processor to:
receive data corresponding to a second virtual object from a remote computerized device; and
cause the live event augmented by the virtual object further augmented with the second virtual object to be displayed.

14. The computer program of claim 13, wherein the behavior of the second virtual object is affected by a second user.

15. The computer program of claim 13, wherein the processor-readable instructions further comprise additional processor-readable instructions configured to cause the processor to:
adjust the behavior of the virtual object in response to the second virtual object.

16. A computer program residing on a non-transitory processor-readable medium and comprising processor-readable instructions configured to cause a processor to:
receive data corresponding to a live event;
cause the live event up to a point in time to be presented;
cause a virtual event at least partially based on an event that occurred during the live event earlier than the point in time to be presented;
receive input linked with the virtual event, wherein the input is received from a user; and
cause an outcome of the virtual event to be presented, wherein the outcome is at least partially based on the input received from the user.

17. The computer program of claim 16, wherein:
the virtual event is at least started being presented when the live event is stopped.

18. The computer program of claim 16, wherein the live event is a sporting event.

19. An apparatus for using augmented reality, the apparatus comprising:
means for receiving a data stream corresponding to a live event, wherein the data stream comprises live video, wherein:
the live video comprises a live object;
means for receiving input from a user, wherein the input from the user affects a behavior of a virtual object; and
means for causing the live event augmented by the virtual object to be presented, wherein a behavior of the live object of the live event affects the behavior of the virtual object.

20. The apparatus for using augmented reality of claim 19, wherein:
the virtual object is caused to be presented such that the virtual object appears to compete with the live object.

21. The apparatus for using augmented reality of claim 19, wherein the live event is a sporting event.

22. The apparatus for using augmented reality of claim 19, further comprising:
means for receiving data corresponding to a second virtual object from a remote computerized device; and
means for causing the live event augmented by the virtual object further augmented with the second virtual object to be displayed.

23. The apparatus for using augmented reality of claim 22, wherein the behavior of the second virtual object is affected by a second user.

24. The apparatus for using augmented reality of claim 22, further comprising:
means for adjusting behavior of the virtual object in response to the second virtual object.

25. An apparatus for using augmented reality, the apparatus comprising:
means for receiving data corresponding to a live event;
means for causing the live event to be presented up to a point in time;
means for causing a virtual event at least partially based on an event that occurred during the live event earlier than the point in time to be presented;
means for receiving input linked with the virtual event, wherein the input is received from a user; and
means for causing an outcome of the virtual event to be presented, wherein the outcome is at least partially based on the input received from the user.

26. The apparatus for using augmented reality of claim 25, wherein:
the virtual event is at least started being presented when the live event is stopped.

27. The apparatus of claim 25, wherein the live event is a sporting event.

28. A device for using augmented reality, the device comprising:
a processor; and
a memory communicatively coupled with and readable by the processor and having stored therein a series of processor-readable instructions which, when executed by the processor, cause the processor to:
receive a data stream corresponding to a live event, wherein the data stream comprises live video, wherein:
the live video comprises a live object;
receive input from a user, wherein the input from the user affects behavior of a virtual object; and
cause the live event augmented by the virtual object to be presented, wherein a behavior of the live object of the live event affects the behavior of the virtual object.

29. The device for using augmented reality of claim 28, wherein
the virtual object is presented such that the virtual object appears to compete with the live object.

30. The device for using augmented reality of claim 28, wherein the live event is a sporting event.

31. The device for using augmented reality of claim 28, wherein the series of processor-readable instructions which, when executed by the processor, further cause the processor to:
receive data corresponding to a second virtual object from a remote computerized device; and
cause the live event augmented by the virtual object further augmented with the second virtual object to be presented.

32. The device for using augmented reality of claim 31, wherein the behavior of the second virtual object is affected by a second user.

33. The device for using augmented reality of claim 31, wherein the series of processor-readable instructions which, when executed by the processor, further cause the processor to:
adjust the behavior of the virtual object in response to the second virtual object.

34. A device for using augmented reality, the device comprising:
a processor; and
a memory communicatively coupled with and readable by the processor and having stored therein a series of processor-readable instructions which, when executed by the processor, cause the processor to:
receive data corresponding to a live event;
cause the live event up to a point in time to be presented;
cause a virtual event at least partially based on an event that occurred during the live event earlier than the point in time to be presented;
receive input linked with the virtual event, wherein the input is received from a user; and
cause an outcome of the virtual event to be presented, wherein the outcome is at least partially based on the input received from the user.

35. The device for using augmented reality of claim 34, wherein:
the virtual event is at least started being presented when the live event is stopped.

36. The device of claim 34, wherein the live event is a sporting event.
